(19) United States
(12) Patent Application Publication
(10) Pub. No.: US 2008/0031086 A1
(43) Pub. Date: Feb. 7, 2008

(54) Rotary slurry distributor

(75) Inventor: Yuxiang Zhang, Pittsburgh, PA (US)

Correspondence Address: Bryan H. Opalko, Esquire;Buchanan Ingersoll & Rooney PC, One Oxford Centre, 20th Floor, 301 Grant Street, Pittsburgh, PA, 15219, US

(73) Assignee: Taggart Global, LLC, Pittsburgh, PA (US)

(21) Appl. No.: 11/888,420

(22) Filed: Aug. 1, 2007

(30) Foreign Application Priority Data
Aug. 3, 2006 (CN) 200620123564.5

(51) Int. Cl. B01F 15/02

(52) U.S. Cl. 366/165.2

(57) ABSTRACT

A rotary slurry distributor is provided, including rotary container. The feeding inlet is mounted on the upper part of the aforesaid rotary container for receiving a mineral slurry. A guide structure is provided on the side wall of the rotary container. Along the rotary container, the guide structure has a tangential angle relative to the horizontal direction. As the mineral slurry falls into the rotary container, the mineral slurry flows through the guide structure and the gravity of the mineral slurry imposes a tangential force on the guide structure so that the rotary container can rotate. The homogenization of the quantity and quality of slurry can be realized using this rotary slurry distributor. The design of the device is smart. The gravity of mineral slurry is used to realize the rotation of the rotary container (no external power is needed) in order to further realize the uniform distribution of mineral slurry.

### FIELD OF THE INVENTION

This novel application concerning material distribution equipment in the technical field of mineral processing is mainly used for the uniform distribution of slurry with large mineral particles, and includes a rotary slurry distributor which can rotate without the use of external power.

### BACKGROUND OF THE INVENTION

At present, the equipment used for the distribution of materials with large particles has the problem of non-uniform distribution. Additionally, external power is generally required. For example, a scraper conveyer can be used to distribute the materials with large particles. However, when used to distribute materials with large particles, the shortcomings of the scraper conveyer are high energy consumption, high level of noise, severe abrasion, high operating cost and large floor space.

The present invention is directed toward overcoming one or more of the above-identified problems.

### SUMMARY OF THE INVENTION

For this novel application, the technical problem to be resolved is to provide a rotary slurry distributor in that the mineral slurry can be distributed uniformly through the rotation of mineral slurry without external power.

In order to resolve the aforesaid technical problem, this novel application provides a rotary slurry distributor, including a rotary container with a feeding inlet on the top. It is characterized by a guide structure on the side wall of the rotary container. Along the rotary container, the guide structure has a tangential angle relative to the horizontal direction. During the process of falling, mineral slurry flows through the guide structure and the gravity of the mineral slurry imposes a tangential force on the guide structure so that the rotary container can rotate.

Advantageously, the internal tank is a rotary container which consists of inclined primary distribution discharge tubes. A fixed external tank accommodates the internal tank, and there is at least one slurry outlet on the bottom of the external tank.

Advantageously, the tilting angle of the primary feed tubes relative to the horizontal direction and along the slope of internal tank can be adjusted. A control flange is equipped on the primary feed tube, and the tilting angle of the primary feed tube can be adjusted through the control flange so that the rotating velocity of the internal tank can be adjusted.

Advantageously, the primary feed tubes are mounted on the upper part of internal tank, and there are a plurality of primary feed tubes uniformly located along the circumferential direction of the internal tank. In addition, secondary feed tubes are located aslant on the internal tank and also constitute the guide structure. The secondary feed tubes are located on the lower part of the internal tank.

Advantageously, the quantity of the secondary feed tubes is preferably equivalent to that of the primary feed tubes, and the secondary feed tubes are arranged alternately along the circumferential directly relatively to the primary feed tubes. However, different numbers of primary and secondary feed tubes may be utilized.

Advantageously, the tilting angle of the primary feed tubes relatively to the horizontal direction and along the tangential direction of internal tank is 15-45°. However, other angles may be implemented.

The rotary slurry distributor of this novel application includes a material-feeding part, a distribution part and a material-discharge part. The material-feeding part includes a material-feeding tube that is located on the top cover of the external tank and is connected to the external tank and the feeding inlet of the internal tank. The distribution part includes the external tank, the internal tank, and the primary and secondary distribution tubes. Mineral slurry enters into the internal tank from the material-feeding tube and further flows into the external tank through the primary and/or secondary tubes. The material-discharge part includes material-discharge tubes located on the bottom of the external tank. Mineral slurry is discharged from the external tank through the material-discharge tubes.

Advantageously, there is multiple material-discharge tubes arranged uniformly along the circumferential direction on the bottom of the external tank.

In addition, the rotary slurry distributor of this novel application includes: (1) a driving unit which includes a rotating shaft connected to the bottom of the internal tank, with the rotating shaft supported on the bearing pedestal through a pair of tapered roller bearings; and (2) a supporting device that includes multiple stands uniformly located on the external wall of the external tank and the supporting barrels used to secure the bearing pedestals and connect them to the bottom of the external tank.

Through the application of the aforesaid technical scheme, this novel invention has the following technical effects:

The rotary slurry distributor of this novel invention does not need external power since the rotation and uniform distribution of mineral slurry are realized depending on the gravity of mineral slurry. The performance of the equipment is good, its running is stable and so it can be used for the material distribution during the processing of various minerals.

Other objects, aspects, and advantages of the present invention can be obtained from a study of the specification, the drawings, and the appended claims.

### BRIEF DESCRIPTION OF THE DRAWINGS

Various other objects, features and advantages of the present invention, in addition to the above, will become readily apparent to those skilled in the art, by reading the following detailed description in conjunction with the drawings, which are shown by way of example only, wherein:

FIG. 1: A sectional view of the rotary slurry distributor of the novel invention;

FIG. 2: A vertical view of the rotary slurry distributor of the novel invention, excluding the top cover of the external tank;

FIG. 3: A sectional view of the distribution part of the rotary slurry distributor;

FIG. 4: A layout of the +upper distribution tubes and the lower distribution tubes of the internal tank; and

FIG. 5: Analysis of forces acting on mineral slurry.

### DETAILED DESCRIPTION OF THE INVENTION

In combination with the attached Figures, the detailed description below of the novel rotary slurry distributor will provide a better understanding of the characteristics and advantages of the novel application.

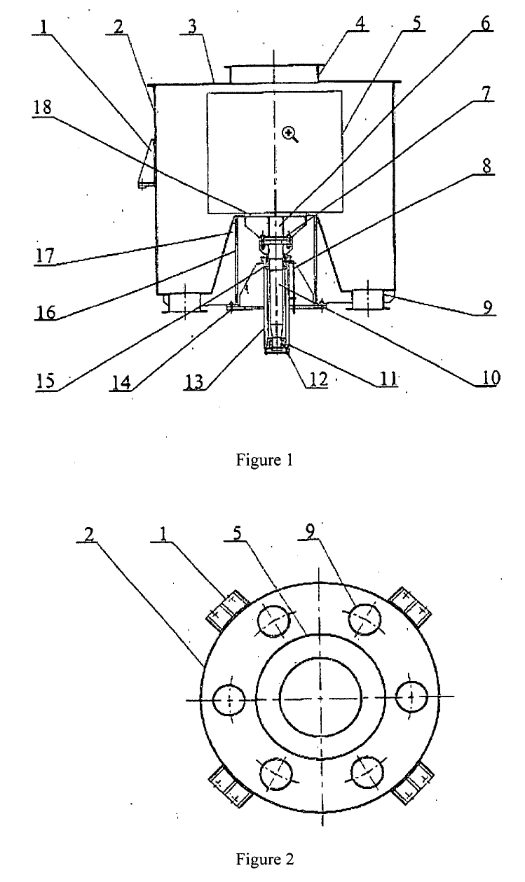

As shown in FIG. 1, the rotary slurry distributor includes a material-feeding part, distribution part, material-discharge part, driving unit and supporting devices.

The material-feeding part includes a material-feeding tube 4 located on the top cover 3 of the external tank 2. The material-feeding tube 4 is connected to the external tank 2 and the feeding inlet of the internal tank 5.

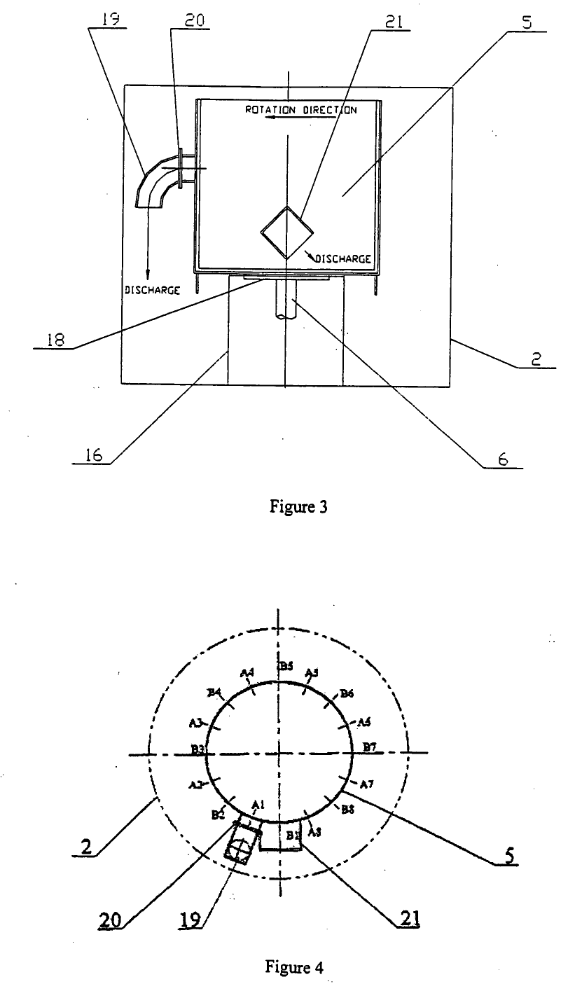

As shown in FIG. 3, the distribution part includes the internal tank 5, the upper distribution tubes 19, the control flanges 20 and the lower distribution tubes 21. There is an opening on the upper part of the internal tank 5 which connects to the material-feeding tube 4. The upper distribution tubes 19 are equipped with control flanges 20 and are located aslant on the upper part of the internal tank 5. The lower distribution tubes 21 are located on the lower part of the internal tank 5. The number of the upper distribution tubes 19 is preferably equivalent to that of the lower distribution tubes 21, and the upper 19 and lower 21 distribution tubes are preferably arranged alternatively along the circumferential direction of the internal tank 5. However, other numbers and arrangements of distribution is contemplated.

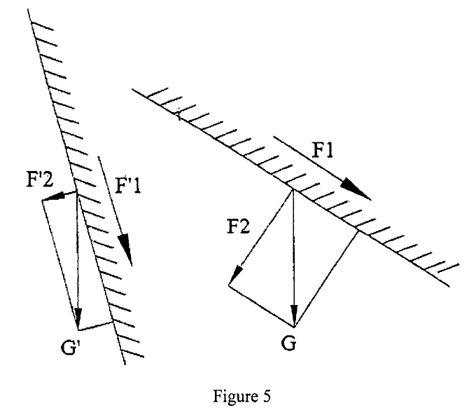

As shown in FIG. 4, the A1-A8 tubes are the upper distribution tubes 19 located along the circumferential direction of the internal tank 5, while the B1-B8 tubes are the lower distribution tubes 21 located along the circumferential direction of the internal tank 5. To facilitate the processing, the lower distribution tubes 21 are preferably designed as quadrate form. As required, the same structure of upper distribution tubes 19 can be adopted for the lower distribution tubes 21.

The material-discharge part includes material-discharge tubes 9 which are located at the bottom of the external tank 2 and through which the mineral slurry is discharged. As shown in FIG. 2, the multiple material-discharge tubes 9 are preferably located uniformly along the circumferential direction at the bottom of the external tank 2.

As shown in FIG. 1, the driving unit includes the joint plate 18, the upper rotating shaft 6, the flange 7 of the rotating shaft 6, the lower rotating shaft 10, the upper tapered roller bearing 15, the upper oil gun 8, the lower tapered roller bearing 12 and the lower oil gun 11. The joint plate 18 connects the internal tank 5 to the upper rotating shaft 6. The upper rotating shaft 6 and the lower rotating shaft 10 are connected through the flange 7 of rotating shaft 6. The lower rotating shaft 10 is jointly supported by the upper tapered roller bearing 15 and the lower tapered roller bearing 12 that are lubricated by the upper oil gun 8 and the lower oil gun 11, respectively.

The supporting device includes supporting pedestals 1, the supporting barrel 16, the connecting bolt 14 and the bearing pedestal 13. The bearing pedestal 13 is connected to the supporting barrel 16 through the connecting bolt 14, so that the internal tank 5 is connected to the supporting barrel 16. The supporting barrel 16 is connected to the external tank 2 through the reinforcing bar 17, and by this way, the various parts of the equipment are connected as a whole. There are four supporting pedestals 1 uniformly arranged on the external wall of the external tank 2. The supporting pedestals 1 are connected to the external support through bolts. All devices of the rotary slurry distributor and the dead/live loads of mineral slurry are carried by the supporting pedestals 1.

The rotary slurry distributor of the present invention operates as follows. The distributed materials in specified liquid/solid ratio enter into the distributor through the upper material-feeding tube 4 of the rotary slurry distributor. Then the materials fall perpendicularly in a free form along the internal tank 5, and are finally discharged through the upper distribution tubes 19 and the lower distribution tubes 21. Since the distribution tubes have a tilting angle along the tangential direction of the internal tank 5 relatively to the horizontal direction, the mineral slurry imposes pressure on the distribution tubes 19 and 21. This pressure is a component of the gravity of the mineral slurry as it falls into the internal tank 5, as shown in FIG. 5. The pressure is related to the angel of the distribution tubes 19 and 21. The smaller the angles between distribution tubes 19 and 21 and the horizontal direction, the higher the component force (pressure) of the gravity G of mineral slurry and the faster the rotating velocity of internal tank 5 within a specified angel range. The angle of the distribution tubes along the tangential direction and relative to the horizontal direction can preferably be selected within the scope of 15-45 degrees. However, other angles are contemplated.

In general, as the angle of the upper distribution tubes 19 can be adjusted to meet various requirement, the angle between the horizontal direction and the outlet direction of the lower distribution tubes 21 may be designed as fixed (i.e., the angle cannot be adjusted) in order to simplify the equipment. During running, the direction of the material outlet of the upper distribution tubes 19 can be adjusted through the control flange 20 mounted on the upper distribution tubes 19. In this manner, the rotating velocity of internal tank 5 can be adjusted, the materials are distributed more uniformly, and the equipment can be protected and its service life is therefore postponed at the same time. The materials are distributed uniformly during rotation. They fall into the external tank 2 through the upper distribution tubes 19 and the lower distribution tubes 21, and discharged through multiple material-discharge tubes 9 located at the bottom of the external tank 2. In this manner, the goal of uniform distribution of materials is realized. The number of material-discharge tubes 9 is typically dependent on the volumes of mineral slurry.

As required, the goal of the distribution of mineral slurry can be realized in the same way when the lower distribution tubes are mounted only in the internal tank. The form of the external tank 2 may not always be the form of cylinder; it can take other forms such as, but not limited to, polygonal.

Using the rotary slurry distributor of this novel invention, mineral slurry of numerous portions can be processed and the homogenization of the quantity and quality of slurry can be realized. This equipment can be broadly used to process the minerals and realize the uniform distribution of slurry. The upper limit of particle size in the slurry can be up to 100 mm. The design of the device is smart. By using the gravity of the mineral slurry to realize the rotation of the tank body, there is no power consumption, the processing capacity is high, the maintenance is simple, the operation is convenient, and the overall performance of the inventive rotary slurry distributor is quite good.

The aforesaid is only the preferred embodiment for this novel invention, and it cannot be used to limit this novel invention. For the technicians in this technical field, this novel invention may have various modifications and changes. Any modification, equivalent replacement or improvement that is carried out in the spirit and principles of this novel application shall be within the protective scope of this novel application.

I claim:

1. A rotary slurry distributor comprising:
a rotary container having a bottom and a side wall, the rotary container having a feed inlet at a top portion thereof; and
guide structure on the side wall of the rotary container, the guide structure having a tangential angle along the rotary container relative to the horizontal direction,
wherein as mineral slurry enters the rotary container through the feed inlet, as the mineral slurry falls it flows through the guide structure and the gravity of the mineral slurry imposes a tangential force on the guide structure which in turn rotates the rotary container.

2. The rotary slurry distributor of claim 1, further comprising an external tank housing the rotary container, the external tank having at least one discharge hole on the bottom thereof,
wherein the rotary container comprises an internal tank housed within the external tank, and
wherein the guide structure comprises primary distribution tubes mounted aslant on the side wall of the internal tank.

3. The rotary slurry distributor of claim 2, wherein the angle of the primary distribution tubes relative to the horizontal direction is adjustable.

4. The rotary slurry distributor of claim 3, wherein the primary distribution tubes each include a control flange, wherein the angle of the primary distribution tubes is adjustable via the control flange so that the rotating velocity of the internal tank can be adjusted.

5. The rotary slurry distributor of claim 4, wherein a plurality of the primary feed tubes are mounted on an upper part of the internal tank and uniformly spaced about a circumference of the internal tank.

6. The rotary slurry distributor of claim 5, wherein the guide structure further comprises secondary feed tubes mounted aslant on the side wall of the internal tank, the secondary feed tubes mounted on a lower part of the internal tank.

7. The rotary slurry distributor of claim 6, wherein equal pluralities of primary and secondary feed tubes are provided and are arranged alternately about the circumference of the internal tank.

8. The rotary slurry distributor of claim 4, wherein the angle of the primary feed tubes relative to the horizontal direction and along a tangential direction of the internal tank is between 15-45 degrees.

9. The rotary slurry distributor of claim 7, further comprising a material-feeding part, a distribution part and a material-discharge part,
wherein the material-feeding part includes a material-feeding tube provided on a top cover of the external tank in fluid communication with the feed inlet of the internal tank,
wherein the distribution part includes the external tank, the internal tank, and the primary and secondary feed tubes, wherein mineral slurry enters the internal tank via the material-feeding tube and flows into the external tank via the primary and secondary feed tubes, and
wherein the material-discharge part includes material-discharge tubes provided on the bottom of the external tank, wherein the mineral slurry is discharged from the external tank via the material-discharge tubes.

10. The rotary slurry distributor of claim 9, the material-discharge tubes comprise a plurality of material-discharge tubes uniformly spaced about a circumference of the external tank.

11. The rotary slurry distributor of claim 9, further comprising a driving unit including a rotating shaft connected to the bottom of the internal tank, wherein the rotating shaft is supported on a bearing pedestal through a pair of tapered roller bearings.

12. The rotary slurry distributor of claim 11, further comprising a supporting device including multiple stands uniformly spaced on the sidewall of the external tank, wherein supporting barrels are used to secure the bearing pedestal and connect it to the bottom of the external tank.
